(19) United States
(12) Patent Application Publication
(10) Pub. No.: US 2025/0093525 A1
(43) Pub. Date: Mar. 20, 2025

(54) SATELLITE SIGNAL RECEIVER AND CONSUMPTION AMOUNT ESTIMATION DEVICE THEREFOR

(71) Applicant: SONY SEMICONDUCTOR SOLUTIONS CORPORATION, KANAGAWA (JP)

(72) Inventor: KAZUKUNI TAKANOHASHI, KANAGAWA (JP)

(21) Appl. No.: 18/729,337

(22) PCT Filed: Nov. 29, 2022
(86) PCT No.: PCT/JP2022/043935

§ 371 Date: Jul. 16, 2024

(30) Foreign Application Priority Data
Jan. 25, 2022 (JP) 2022-009208

(51) Int. Cl. G01S 19/34; G01S 19/23

(52) U.S. Cl. CPC G01S 19/34; G01S 19/23

(57) ABSTRACT

A consumption amount in a satellite signal receiver is estimated. The satellite signal receiver includes multiple control blocks including a front-end control block for receiving a satellite signal from a satellite and performing signal processing, a satellite capture control block for capturing the satellite signal, a satellite tracking control block for tracking the satellite signal, and a positioning control block for measuring a position of the satellite signal receiver on the basis of the satellite signal. A consumption information holding unit holds consumption information in which a first consumption amount is estimated in advance for each of the multiple control blocks. A consumption amount estimation unit estimates a second consumption amount in a predetermined period on a basis of the consumption information according to the operation state of each of the multiple control blocks within the predetermined period.

### TECHNICAL FIELD

The present technology relates to a satellite signal receiver that receives a satellite signal from a satellite and generates position information. Specifically, the present technology relates to a satellite signal receiver that estimates a consumption amount during operation of the satellite signal receiver and a consumption amount estimation device therefor.

### BACKGROUND ART

A global navigation satellite system (GNSS) is a system that receives a satellite signal from a positioning satellite and measures a position on the ground. A ground-side reception device that performs positioning using a positioning satellite system is hereinafter referred to as a satellite signal receiver. As such a satellite signal receiver, various devices have been proposed (see, for example, Patent Document 1).

### CITATION LIST

### Patent Document

Patent Document 1: WO 03-104839 A

### SUMMARY OF THE INVENTION

### Problems to be Solved by the Invention

In order to improve performance in the satellite signal receiver, it is necessary to operate many functional blocks, and accordingly, power consumption increases. Therefore, in the case of application to a mobile device, there is a problem that battery consumption becomes severe. In addition, there is a property that power consumption dynamically fluctuates depending on a reception environment. Furthermore, unlike other types of receivers, it is important that the position can be measured with a certain degree of accuracy rather than a choice of whether or not reception is enabled. Therefore, it is required to know how much power is consumed in the operating environment of the satellite signal receiver.

The present technology has been made in view of such a situation, and an object thereof is to estimate a consumption amount of power or the like in a satellite signal receiver.

### Solutions to Problems

The present technology has been made to solve the above-described problems, and a first aspect thereof is a satellite signal receiver and a consumption amount estimation device, including: a consumption information holding unit that holds consumption information in which a first consumption amount is estimated in advance for each of a plurality of control blocks in a satellite signal receiver that receives a satellite signal from a satellite and generates position information; and a consumption amount estimation unit that estimates a second consumption amount in a predetermined period on the basis of the consumption information according to an operation state of each of the plurality of control blocks within the predetermined period. This brings about an effect of estimating the second consumption amount in the predetermined period according to the operation state of the satellite signal receiver.

Furthermore, in the first aspect, the plurality of control blocks may include a front-end control block for receiving the satellite signal and performing signal processing, and the consumption information may include the first consumption amount according to a height of an analog-to-digital conversion sampling frequency, a height of a clock frequency, or presence or absence of operation of a noise filter for each frequency band of the satellite signal.

Furthermore, in the first aspect, the plurality of control blocks may include a satellite capture control block for capturing the satellite signal, and the consumption information may include the first consumption amount according to a number of satellites related to the satellite signal to be simultaneously captured, a height of a clock frequency, or a parameter for capturing the satellite signal.

Furthermore, in the first aspect, the plurality of control blocks may include a satellite tracking control block for tracking the satellite signal, and the consumption information may include the first consumption amount for each channel according to a synchronization parameter for each of the satellite signals, a decoding state for each of the satellite signals, or a height of a clock frequency.

Furthermore, in the first aspect, the plurality of control blocks may include a positioning control block for measuring a position of the satellite signal receiver on the basis of the satellite signal, and the consumption information may include the first consumption amount according to the number of satellites used to measure the position of the satellite signal receiver.

Furthermore, in the first aspect, for example, the first consumption amount is consumption current estimated in advance, and the second consumption amount is power consumption estimated during operation.

Furthermore, in the first aspect, the consumption information may include the first consumption amount per processing time in the plurality of control blocks, and the consumption amount estimation unit may estimate the second consumption amount on the basis of time required for processing in the plurality of control blocks.

### BRIEF DESCRIPTION OF DRAWINGS

FIG. 1 is a diagram illustrating a configuration example of a positioning satellite system according to a first embodiment of the present technology.

FIG. 2 is a diagram illustrating an example of control blocks of a satellite signal receiver 100 according to the first embodiment of the present technology.

FIG. 3 is a diagram illustrating a configuration example of a power estimation unit 150 according to the first embodiment of the present technology.

FIG. 4 is a diagram illustrating an example of a frequency band of a satellite signal according to the first embodiment of the present technology.

FIG. 5 is a diagram illustrating a configuration example of a front-end control block 191 according to the first embodiment of the present technology.

FIG. 6 is a diagram illustrating an example of a reference table corresponding to the operation of the front-end control block 191 according to the first embodiment of the present technology.

FIG. 7 is a diagram illustrating an example of a reference table corresponding to the operation of a satellite capture control block 192 according to the first embodiment of the present technology.

FIG. 8 is a diagram illustrating an example of a reference table corresponding to the operation of a satellite tracking control block 193 according to the first embodiment of the present technology.

FIG. 9 is a diagram illustrating an example of a reference table corresponding to the operation of a positioning control block 194 according to the first embodiment of the present technology.

FIG. 10 is a diagram illustrating an example of a reference table corresponding to an operation of another block in the first embodiment of the present technology.

FIG. 11 is a diagram illustrating an example of a power consumption estimation timing according to the first embodiment of the present technology.

FIG. 12 is a diagram illustrating an example of a table structure for consumption current estimation according to the first embodiment of the present technology.

FIG. 13 is a diagram illustrating an example of a table structure for consumption current estimation according to the first embodiment of the present technology.

FIG. 14 is a diagram illustrating an example of a table structure of a simultaneous capture satellite number table according to the first embodiment of the present technology.

FIG. 15 is a diagram illustrating an example of a table structure of a clock frequency table according to the first embodiment of the present technology.

FIG. 16 is a diagram illustrating an example of a table structure of a captured parameter table according to the first embodiment of the present technology.

FIG. 17 is a diagram illustrating an estimation example of a consumption current of the satellite capture operation according to the first embodiment of the present technology.

FIG. 18 is a flowchart illustrating an example of a processing procedure of the satellite signal receiver 100 according to the first embodiment of the present technology.

FIG. 19 is a diagram illustrating a configuration example of a positioning satellite system according to a second embodiment of the present technology.

### MODE FOR CARRYING OUT THE INVENTION

A mode for carrying out the present technology (hereinafter, referred to as an embodiment) is hereinafter described. The description will be given in the following order.
1. First embodiment (example of power estimation in satellite signal receiver)
2. Second embodiment (example of estimating power in host computer)

### 1. First Embodiment

### Positioning Satellite System

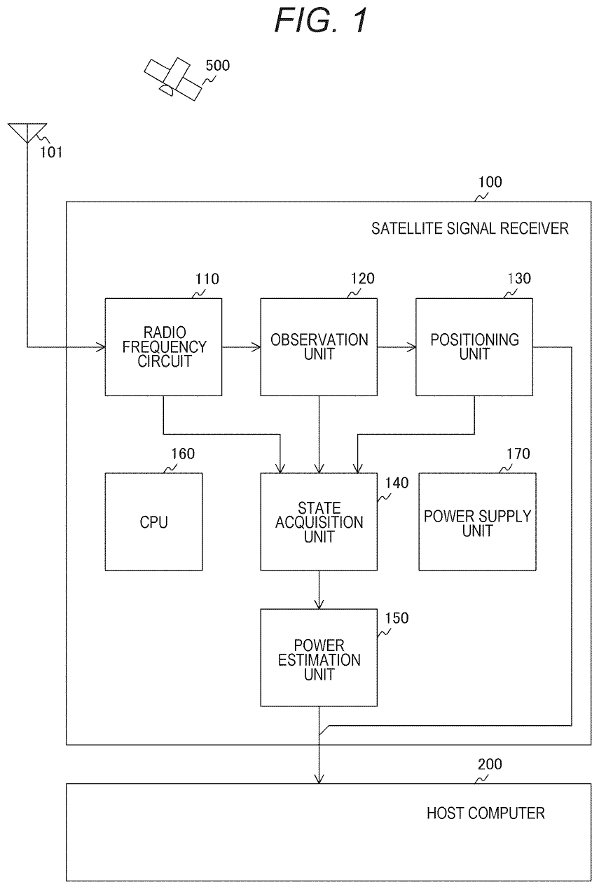

FIG. 1 is a diagram illustrating a configuration example of a positioning satellite system according to a first embodiment of the present technology. This positioning satellite system includes a positioning satellite 500, a satellite signal receiver 100, and a host computer 200.

The positioning satellite 500 is an artificial satellite that transmits a satellite signal for measuring a position of the satellite signal receiver 100 on the ground. As such a positioning satellite 500, for example, a Global Positioning System (GPS) (United States), a Global Navigation Satellite System (GLONASS) (Russia), Galileo (European Union), BeiDou (China), a Quasi-Zenith Satellite System (QZSS) (Michibiki (Japan)), a Navigation Indian Constellation (NavIC), or the like is used.

The satellite signal receiver 100 is a device that receives a satellite signal from the positioning satellite 500 and performs positioning. The satellite signal receiver 100 includes an antenna 101, a radio frequency circuit 110, an observation unit 120, a positioning unit 130, a state acquisition unit 140, a power estimation unit 150, a CPU 160, and a power supply unit 170.

The radio frequency circuit 110 receives the satellite signal from the positioning satellite 500 as a radio frequency signal through the antenna 101 and converts the signal into a digital signal.

The observation unit 120 captures and tracks the positioning satellite 500 on the basis of the received satellite signal.

The positioning unit 130 measures a position of the satellite signal receiver 100 on the basis of the received satellite signal. The measurement result generated by the positioning unit 130 is output as positioning data. As an output format (format) in this case, for example, it is assumed to conform to the NMEA0183 standard.

The state acquisition unit 140 acquires a reception state in each control block of the satellite signal receiver 100.

The power estimation unit 150 estimates power consumption in the satellite signal receiver 100 on the basis of the reception state acquired by the state acquisition unit 140. The estimation result generated by the power estimation unit 150 is output as estimation data. As an output format (format) in this case, for example, it is assumed that a unique sentence using the NMEA0183 standard used for positioning data is adopted. Furthermore, the present invention is not limited thereto, and a unique output format may be adopted.

A central processing unit (CPU) 160 controls operation of each unit of the satellite signal receiver 100. The power supply unit 170 supplies power to each unit of the satellite signal receiver 100.

The host computer 200 performs predetermined processing on the positioning data and the estimation data output from the satellite signal receiver 100. For example, it is assumed that contents of positioning data and estimation data are displayed on a display as a graphical user interface (GUI).

### Control Block

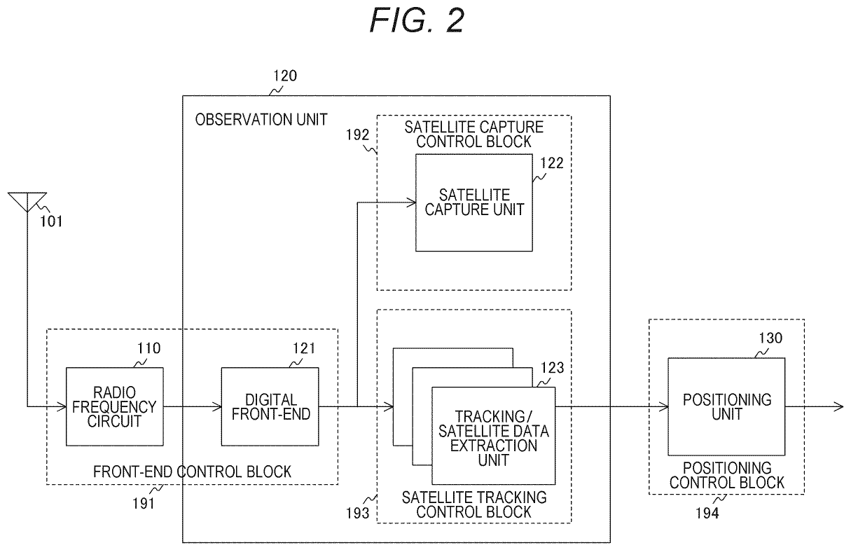

FIG. 2 is a diagram illustrating an example of control blocks of the satellite signal receiver 100 according to the first embodiment of the present technology.

The observation unit 120 described above includes a digital front-end 121, a satellite capture unit 122, and a tracking/satellite data extraction unit 123.

The digital front-end 121 performs predetermined signal processing on the satellite signal received by the radio frequency circuit 110 and converted into a digital signal.

The satellite capture unit 122 captures the positioning satellite 500 on the basis of the satellite signal output from the digital front-end 121.

The tracking/satellite data extraction unit 123 tracks the positioning satellite 500 on the basis of the satellite signal output from the digital front-end 121 and extracts satellite data. The tracking/satellite data extraction unit 123 is provided with a plurality of tracking/satellite data extraction units 123 in the number corresponding to the number of channels of the satellite signal.

In the present embodiment, power estimation is performed by dividing the satellite signal receiver 100 into a plurality of blocks as follows. First, the radio frequency circuit 110 and the digital front-end 121 are referred to as a front-end control block 191. Further, the satellite capture unit 122 is referred to as a satellite capture control block 192. In addition, the plurality of tracking/satellite data extraction units 123 are referred to as a satellite tracking control block 193. Further, the positioning unit 130 is referred to as a positioning control block 194.

### Power Estimation Unit

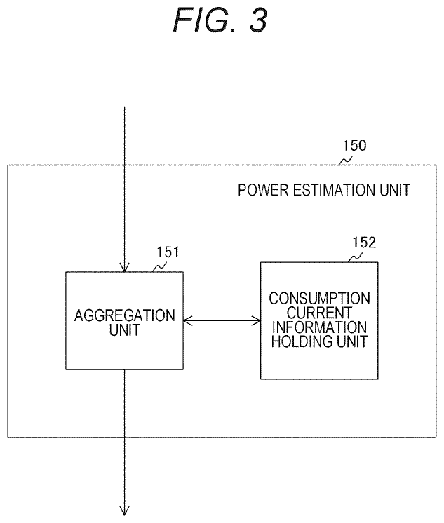

FIG. 3 is a diagram illustrating a configuration example of the power estimation unit 150 according to the first embodiment of the present technology. The power estimation unit 150 includes an aggregation unit 151 and a consumption current information holding unit 152.

The consumption current information holding unit 152 holds consumption current information for each control block of the satellite signal receiver 100. As described later, the consumption current information is a data group in which the correspondence relationship between the reception state and the consumption current is estimated in advance.

The aggregation unit 151 refers to the consumption current information held in the consumption current information holding unit 152 and aggregates the consumption current on the basis of the reception state during operation. In this aggregation, the consumption current as a whole is aggregated by adding the consumption current estimated in advance in each table of the consumption current information on the basis of a fixed current such as a leakage current in the satellite signal receiver 100.

In addition, the aggregation unit 151 estimates power consumption on the basis of the aggregated consumption current and outputs data of the estimated power consumption.

### Frequency Band of Satellite Signal

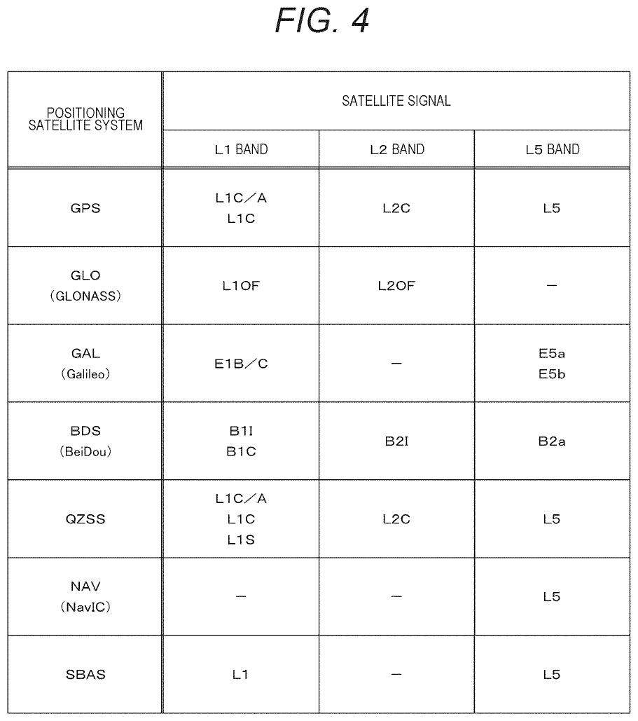

FIG. 4 is a diagram illustrating an example of a frequency band of a satellite signal according to the first embodiment of the present technology.

In a left column of the drawing, the name of the positioning satellite system is illustrated. Here, in addition to the GPS, GLONASS, Galileo, BeiDou, QZSS, and NavIC described above, an SBAS (Satellite Based Augmentation System) having overlapping frequency bands is also illustrated.

The frequency band of the satellite signal of the positioning satellite system is mainly roughly divided into an L1 band, an L2 band, and an L5 band. A right column in the drawing illustrates a satellite signal corresponding to a positioning satellite system for each frequency band.

The user of the satellite signal receiver 100 selects a satellite signal desired to be used for positioning. Then, a frequency band is determined according to the selected satellite signal. In a case where at least one signal in the frequency band is selected, the reception processing in the front-end control block 191 for the frequency band is enabled.

### Front-End Control Block

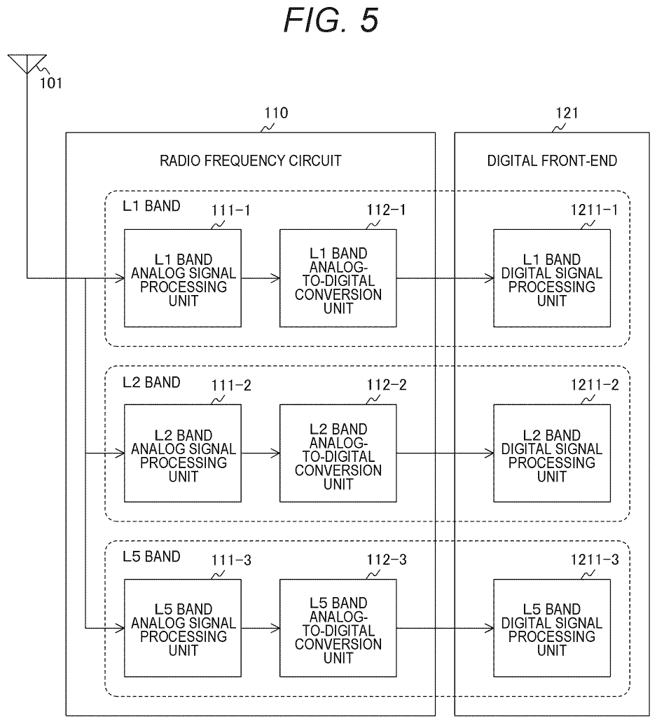

FIG. 5 is a diagram illustrating a configuration example of the front-end control block 191 according to the first embodiment of the present technology.

The front-end control block 191 is configured to operate independently for each frequency band. An analog signal processing unit that performs analog signal processing of the radio frequency signal is divided into an L1 band analog signal processing unit 111-1, an L2 band analog signal processing unit 111-2, and an L5 band analog signal processing unit 111-3. Furthermore, an analog-to-digital conversion unit that converts an analog signal into a digital signal is divided into an L1 band analog-to-digital conversion unit 112-1, an L2 band analog-to-digital conversion unit 112-2, and an L5 band analog-to-digital conversion unit 112-3. Furthermore, a digital signal processing unit that performs digital signal processing is divided into an L1 band digital signal processing unit 1211-1, an L2 band digital signal processing unit 1211-2, and an L5 band digital signal processing unit 1211-3.

That is, in a case where the reception processing of the L1 band is performed, the L1 band analog signal processing unit 111-1, the L1 band analog-digital conversion unit 112-1, and the L1 band digital signal processing unit 1211-1 operate. In addition, in a case where the L2 band reception processing is performed, the L2 band analog signal processing unit 111-2, the L2 band analog-to-digital conversion unit 112-2, and the L2 band digital signal processing unit 1211-2 operate. Furthermore, in a case where the reception processing of the L5 band is performed, the L5 band analog signal processing unit 111-3, the L5 band analog-digital conversion unit 112-3, and the L5 band digital signal processing unit 1211-3 operate.

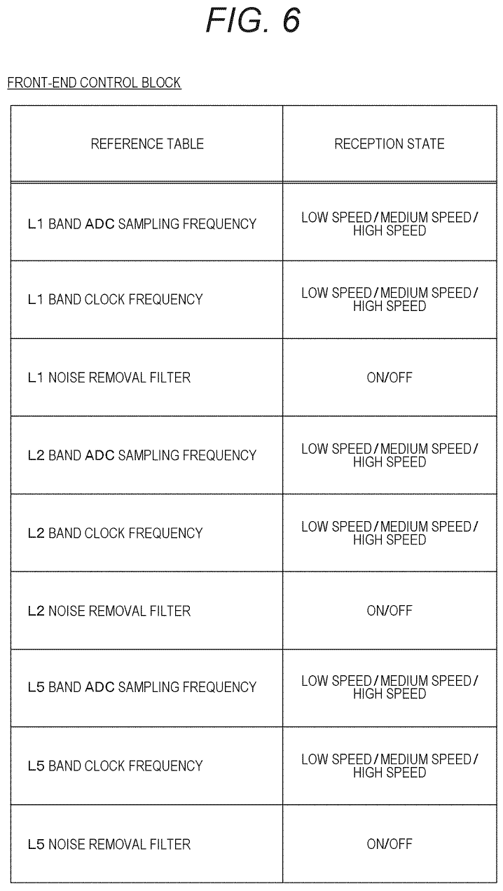

FIG. 6 is a diagram illustrating an example of a reference table corresponding to the operation of the front-end control block 191 according to the first embodiment of the present technology.

As described above, the aggregation unit 151 aggregates the consumption current on the basis of the reception state during operation with reference to the consumption current information estimated in advance and held in the consumption current information holding unit 152. As the consumption current information, the table illustrated in the drawing is referred to for each frequency band for the front-end control block. That is, the table is not referred to for the frequency band for which the reception processing is not performed, and the consumption current is not added. In a case where the reception processing of the L1 band is performed, an L1 band ADC sampling frequency table, an L1 band clock frequency table, and an L1 noise removal filter table are referred to. In a case where the reception processing of the L2 band is performed, an L2 band ADC sampling frequency table, an L2 band clock frequency table, and an L2 noise removal filter table are referred to. In a case where the reception processing of the L5 band is performed, an L5 band ADC sampling frequency table, an L5 band clock frequency table, and an L5 noise removal filter table are referred to.

The L1 band ADC sampling frequency table is a table that holds the consumption current increased or decreased by an ADC (analog-to-digital conversion) for the reception processing of the L1 band for each speed of the sampling frequency. The L1 band clock frequency table is a table that holds the consumption current increased or decreased by the reception processing of the LI band for each clock frequency. The L1 noise removal filter table is a table that holds the consumption current increased or decreased by the reception processing of the L1 band according to the presence or absence of the operation of the noise removal filter. Note that the reference tables for reception processing of the other L2 band and L5 band have similar contents, and thus detailed description thereof will be omitted.

All the consumption currents thus obtained for the front-end control block are added up and aggregated in the aggregation unit 151 as a consumption current required for the front-end control block.

### Satellite Capture Control Block

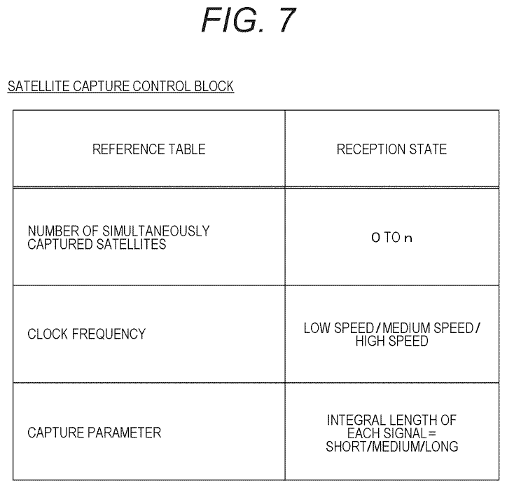

FIG. 7 is a diagram illustrating an example of a reference table corresponding to the operation of the satellite capture control block 192 according to the first embodiment of the present technology.

For the satellite capture control block, the table illustrated in the drawing is referred to in a case where the satellite capture operation is performed. That is, in a case where the satellite capture operation is not performed, the table is not referred to, and the consumption current is not added. In a case where the satellite capture operation is performed, the simultaneous capture satellite number table, the clock frequency table, and the capture parameter table are referred to.

The simultaneous capture satellite number table is a table that holds the consumption current increased or decreased by the satellite capture operation according to the number of satellites to be simultaneously captured. The clock frequency table is a table that holds the consumption current increased or decreased by the satellite capture operation according to the clock frequency. The capture parameter table is a table that holds the consumption current increased or decreased by the satellite capture operation according to an integral length of each satellite signal.

All the consumption currents thus obtained for the satellite capture control block are added up and aggregated in the aggregation unit 151 as the consumption current required for the satellite capture control block.

### Satellite Tracking Control Block

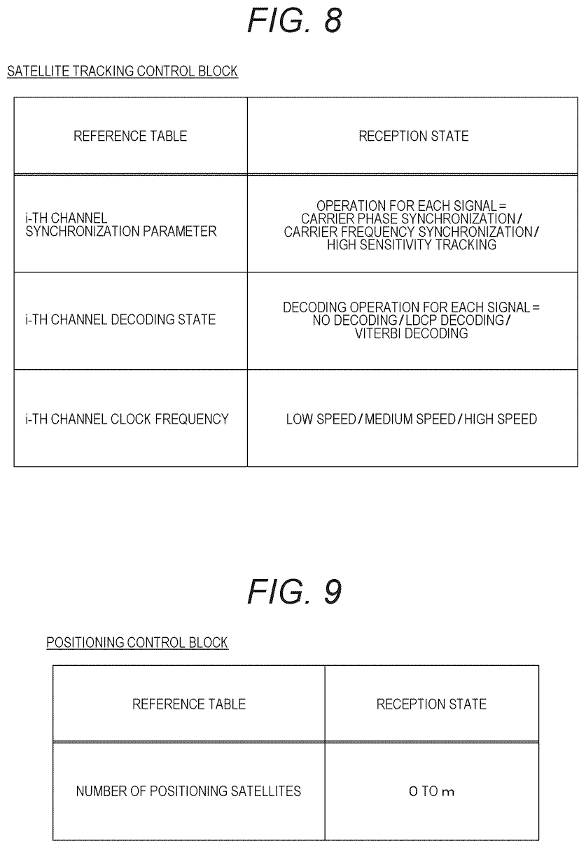

FIG. 8 is a diagram illustrating an example of a reference table corresponding to the operation of the satellite tracking control block 193 according to the first embodiment of the present technology.

For the satellite tracking control block, in a case where the satellite tracking operation is performed, the table illustrated in the drawing is referred to for each channel on which the operation is performed. That is, the table is not referred to for the channel that does not perform the operation, and the consumption current is not added. An i-th channel synchronization parameter table, an i-th channel decoding state table, and an i-th channel clock frequency table are referred to for the channel (hereinafter, referred to as an “i-th channel”) on which the satellite tracking operation is performed.

The i-th channel synchronization parameter table is a table that holds consumption current that increases and decreases due to each of carrier phase synchronization, carrier frequency synchronization, and high sensitivity tracking as a synchronization operation for each satellite signal in the i-th channel. The i-th channel decoding state table is a table that holds consumption current that increases and decreases depending on each of a case where decoding is not performed, a case where LDCP decoding is performed, and a case where Viterbi decoding is performed as decoding operation for each satellite signal in the i-th channel. The i-th channel clock frequency table is a table that holds the consumption current increased or decreased by satellite tracking in the i-th channel according to the clock frequency.

All the consumption currents thus obtained for the satellite tracking control block are added up and aggregated in the aggregation unit 151 as the consumption current required for the satellite tracking control block.

### Positioning Control Block

FIG. 9 is a diagram illustrating an example of a reference table corresponding to the operation of the positioning control block 194 according to the first embodiment of the present technology.

For the positioning control block, a positioning satellite number table is referred to in a case where the positioning operation is performed. That is, in a case where the positioning operation is not performed, the table is not referred to, and the consumption current is not added.

The positioning satellite number table is a table that holds consumption current increased or decreased by a positioning operation according to the number of satellites used for positioning.

The consumption current thus obtained for the positioning control block is aggregated in the aggregation unit 151 as the consumption current required for the positioning control block.

### Other Blocks

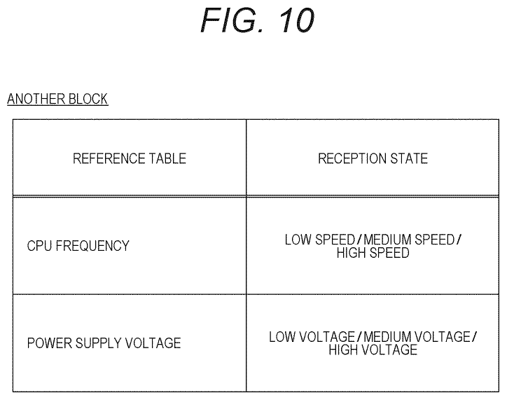

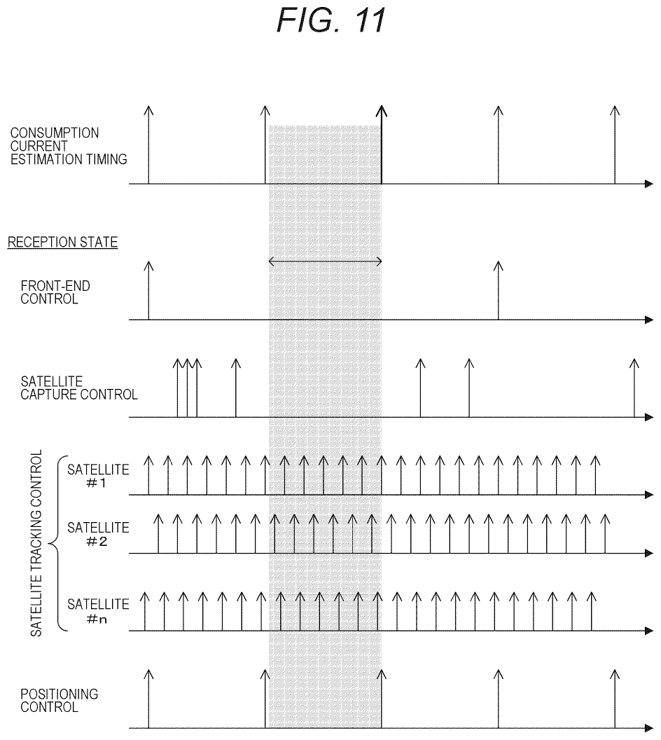

FIG. 10 is a diagram illustrating an example of a reference table corresponding to an operation of another block in the first embodiment of the present technology.

In addition to the above-described control blocks, consumption current may also occur in the CPU 160, the power supply unit 170, and the like. For example, a CPU frequency table and a power supply voltage table are referred to.

The CPU frequency table is a table that holds consumption current that increases and decreases depending on the operation frequency in the CPU 160 according to the frequency of the CPU 160. The power supply voltage table is a table that holds the consumption current increased or decreased by the voltage in the power supply unit 170 according to the height of the voltage of the power supply unit 170.

All the consumption currents obtained in this manner are added up and aggregated in the aggregation unit 151 as consumption currents in the other blocks.

### Power Consumption Estimation Timing

FIG. 11 is a diagram illustrating an example of a power consumption estimation timing according to the first embodiment of the present technology.

In the satellite signal receiver 100, each of the control blocks operates asynchronously with each other. Therefore, when estimating the power consumption, assuming an estimated cycle, the aggregation unit 151 acquires the consumption current required for the operation generated in the estimated cycle from the consumption current information holding unit 152 and aggregates the consumption current. At this time, for example, regarding the front-end control in the drawing, it is assumed that the operation is not updated within the estimation cycle, but the operation is performed while maintaining the state updated at the timing of an immediately preceding arrow, and the power is estimated on the basis of the state.

Note that, regarding the satellite capture control and the decoding control, when the instructed processing is completed, the operation ends, and thus, the start and end of certain control are paired. That is, the satellite capture control and the decoding control operate for a certain period. In the termination, a switch can be detected by polling or interruption. In addition, since these processing move with respect to an instruction to which a certain parameter set is assigned, a power value for the instruction may be estimated in advance, the power value may be added after the start, and the termination may not be considered. For other controls, the operation is always continued. Therefore, the operation parameter is updated at the timing of the arrow.

The aggregation unit 151 aggregates the added consumption current on the basis of the fixed current such as the leakage current, estimates the power consumption on the basis of the aggregated consumption current, and outputs data of the estimated power consumption.

As another method, the consumption current per processing time in the plurality of control blocks may be held in advance, the time required for the processing in the plurality of control blocks may be measured, and the consumption current may be aggregated by multiplying the consumption current per processing time by the time actually required to estimate the power consumption.

### Estimation of Consumption Current

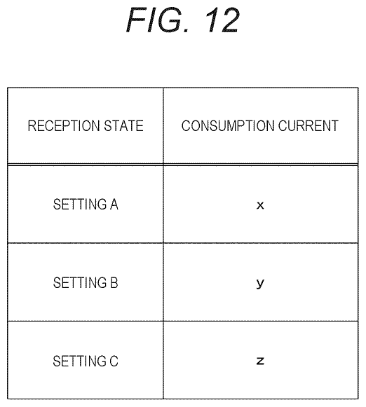

FIG. 12 is a diagram illustrating an example of a table structure for estimating consumption current according to the first embodiment of the present technology.

As described above, the consumption current information holding unit 152 includes the corresponding reference table for each control block. Here, in order to describe the basic operation, a relationship between the table structure and the estimation of the consumption current will be described. The reference table is a table obtained by measuring power consumption that increases and decreases according to a reception state in advance, and holds a plurality of records in which the reception state and the power consumption are paired. In this example, it is held that the consumption current that increases and decreases is x in a case where the reception state is the setting A, the consumption current that increases and decreases is y in the case where the reception state is the setting B, and the consumption current that increases and decreases is z in the case where the reception state is the setting C.

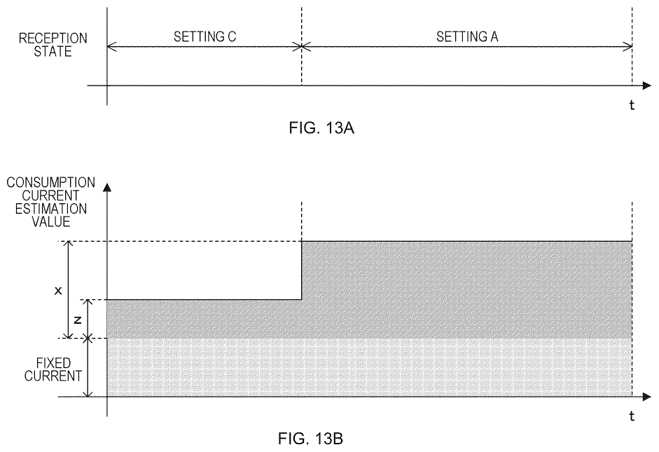

FIG. 13 is a diagram illustrating an example of a table structure for estimating consumption current according to the first embodiment of the present technology.

In this example, as illustrated in a of the drawing, it is assumed that the reception state changes from the setting C to the setting A. In this case, as illustrated in b of the drawing, in the period of the setting C, the current obtained by adding z to the fixed current is estimated as the consumption current in the period. Then, in the period of the setting A, the current obtained by adding x to the fixed current is estimated as the consumption current in the period.

### Specific Examples

Hereinafter, as a specific example, an estimation example of the consumption current of the satellite capture operation will be described.

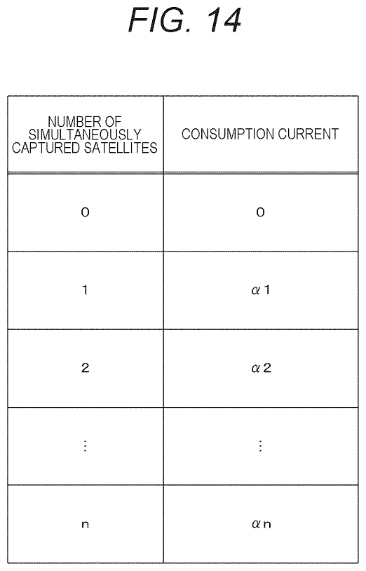

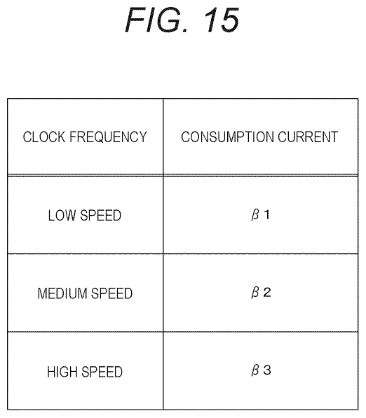

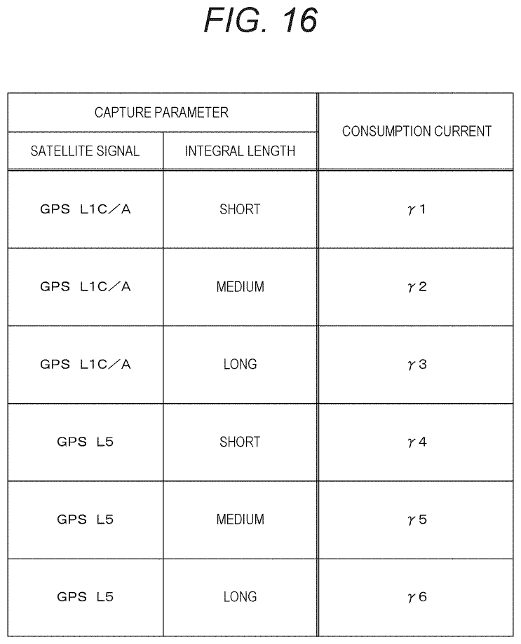

FIG. 14 is a diagram illustrating an example of a table structure of the simultaneous capture satellite number table according to the first embodiment of the present technology. FIG. 15 is a diagram illustrating an example of a table structure of a clock frequency table according to the first embodiment of the present technology. FIG. 16 is a diagram illustrating an example of a table structure of the captured parameter table according to the first embodiment of the present technology.

The aggregation unit 151 aggregates the consumption current with reference to these tables held in the consumption current information holding unit 152.

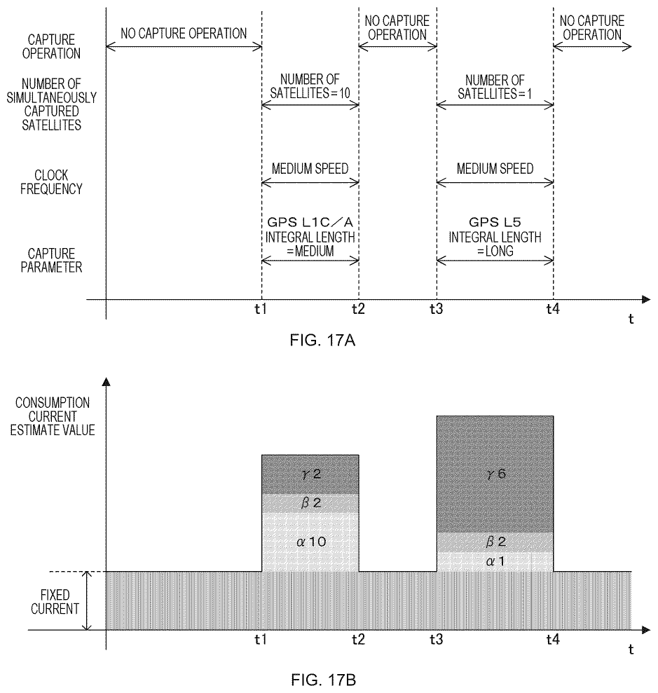

FIG. 17 is a diagram illustrating an estimation example of the consumption current of the satellite capture operation according to the first embodiment of the present technology.

In this example, it is assumed that the capture operation is performed between time t1 and time t2 and between time t3 and time t4. Between time t1 and time t2, it is assumed that the number of simultaneously captured satellites is 10 (α10), the clock frequency is medium (β2), and the integral length is medium (γ2) according to an L1C/A signal of the GPS as a captured parameter. That is, in this period, in addition to the fixed current, α10, β2, and γ2 are added as the consumption current of the satellite capture operation.

In addition, between time t3 and time t4, it is assumed that the number of simultaneously captured satellites is one (α1), the clock frequency is medium (β2), and the captured parameter is captured using a longer integration length by an L5 signal of the GPS (γ6). That is, in this period, in addition to the fixed current, α1, β2, and γ6 are added as the consumption current of the satellite capture operation.

In other periods, since the satellite capture operation is not performed, the consumption current caused by the satellite capture operation is not added.

As described above, in the aggregation unit 151, the consumption current is estimated with reference to the table held in the consumption current information holding unit 152 according to the reception state. Here, the satellite capture operation by the satellite capture control block has been described as an example, but the addition is also similarly performed for operations in other control blocks. After the addition of all the consumption currents for the estimation period is completed, the power consumption is estimated on the basis of the consumption current.

### Procedure

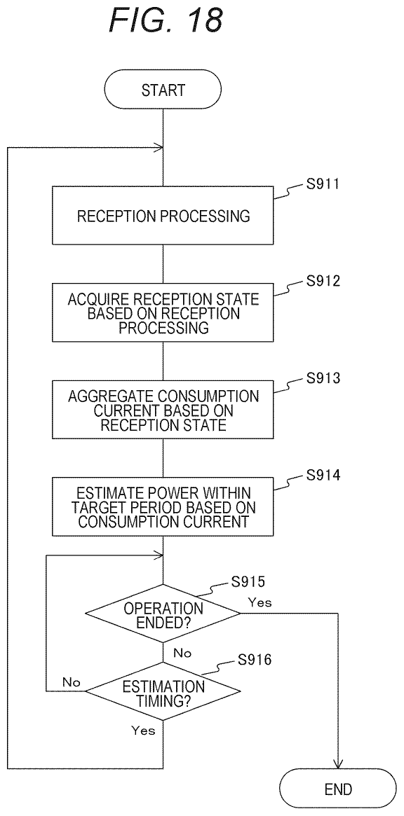

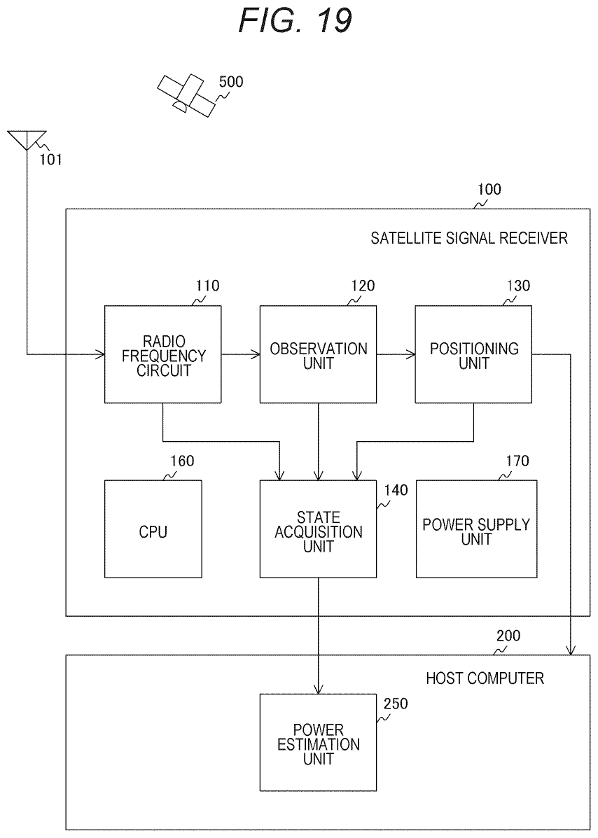

FIG. 18 is a flowchart illustrating an exemplary procedure of the satellite signal receiver 100 according to the first embodiment of the present technology.

In the satellite signal receiver 100, a satellite signal is received in the radio frequency circuit 110, a satellite is supplemented and tracked in the observation unit 120, and positioning is performed on the basis of the satellite signal in the positioning unit 130 (step S911). The state acquisition unit 140 acquires the reception state within an estimation period on the basis of these series of reception processing (step S912).

Next, the power estimation unit 150 aggregates the consumption current by reference to the table as described above on the basis of the reception state acquired by the state acquisition unit 140 (step S913). Then, the power estimation unit 150 estimates the power consumption on the basis of the aggregated consumption current (step S914).

In a case where the operation of the power estimation is ended (Step S915: Yes), this processing is ended. In a case where the operation of power estimation is continued (step S915: No), the processing waits until the next estimation timing arrives (step S916: No). When the next estimation timing arrives (step S916: Yes), step S911 and the subsequent steps are repeated.

As described above, in the first embodiment of the present technology, the power consumption by the control block is measured in advance and held in the consumption current information holding unit 152, and the aggregation unit 151 aggregates the consumption current with reference to the consumption current information holding unit 152 according to the reception state. As a result, the power consumption of the satellite signal receiver 100 can be estimated according to the actual results of the reception state.

### 2. Second Embodiment

In the above-described first embodiment, the power consumption is estimated in the power estimation unit 150 of the satellite signal receiver 100. On the other hand, in a second embodiment, a host computer 200 outside a satellite signal receiver 100 estimates the power consumption.

### Positioning Satellite System

FIG. 19 is a diagram illustrating a configuration example of a positioning satellite system according to the second embodiment of the present technology.

In the positioning satellite system according to the second embodiment, the host computer 200 includes a power estimation unit 250. The power estimation unit 250 estimates power consumption in the satellite signal receiver 100 on the basis of a reception state acquired by a state acquisition unit 140 of the satellite signal receiver 100. Similarly to the power estimation unit 150, the power estimation unit 250 includes an aggregation unit and a consumption current information holding unit (not illustrated). Therefore, even in a case where the satellite signal receiver 100 does not have a function of estimating its own power consumption, the host computer 200 can estimate the power.

Note that the configuration other than the configuration related to the power estimation unit 250 is similar to that of the first embodiment described above, and thus a detailed description thereof will be omitted.

As described above, according to the second embodiment of the present technology, the power consumption of the satellite signal receiver 100 can be estimated according to actual results of the reception state by aggregating the consumption current in the host computer 200 according to the reception state.

Note that the embodiments described above show examples for embodying the present technology, and the matters in the embodiments and the matters specifying the invention in the claims have corresponding relationships, respectively. Similarly, the matters specifying the invention in the claims and matters with the same names in the embodiments of the present technology have correspondence relationships, respectively. However, the present technology is not limited to the embodiments, and can be embodied by applying various modifications to the embodiments without departing from the gist of the present technology.

Furthermore, the procedures described in the above-described embodiment may be considered as a method including a series of procedures and may be considered as a program for allowing a computer to execute the series of procedures and a recording medium which stores the program. As this recording medium, for example, a compact disc (CD), a MiniDisc (MD), a digital versatile disc (DVD), a memory card, a Blu-ray (registered trademark) disc, and the like can be used.

Note that effects described in the present specification are merely examples and are not limited, and there may also be other effects.

Note that the present technology may also have the following configuration.

(1) A consumption amount estimation device for a satellite signal receiver, including:
a consumption information holding unit that holds consumption information in which a first consumption amount is estimated in advance for each of a plurality of control blocks in a satellite signal receiver that receives a satellite signal from a satellite and generates position information; and
a consumption amount estimation unit that estimates a second consumption amount in a predetermined period on a basis of the consumption information according to an operation state of each of the plurality of control blocks within the predetermined period.

(2) The consumption amount estimation device for a satellite signal receiver according to the above (1), in which
the plurality of control blocks includes a front-end control block for receiving the satellite signal and performing signal processing, and
the consumption information includes the first consumption amount according to a height of an analog-to-digital conversion sampling frequency, a height of a clock frequency, or presence or absence of operation of a noise filter for each frequency band of the satellite signal.

(3) The consumption amount estimation device for a satellite signal receiver according to the above (1) or (2), in which
the plurality of control blocks includes a satellite capture control block for capturing the satellite signal, and
the consumption information includes the first consumption amount according to the number of satellites related to the satellite signal to be simultaneously captured, a height of a clock frequency, or a parameter for capturing the satellite signal.

(4) The consumption amount estimation device for a satellite signal receiver according to any one of the above (1) to (3), in which
the plurality of control blocks includes a satellite tracking control block for tracking the satellite signal, and
the consumption information includes the first consumption amount for each channel according to a synchronization parameter for each of the satellite signals, a decoding state for each of the satellite signals, or a height of a clock frequency.

(5) The consumption amount estimation device for a satellite signal receiver according to any one of the above (1) to (4), in which
the plurality of control blocks includes a positioning control block for measuring a position of the satellite signal receiver on a basis of the satellite signal, and
the consumption information includes the first consumption amount according to the number of satellites used to measure the position of the satellite signal receiver.

(6) The consumption amount estimation device for a satellite signal receiver according to any one of the above (1) to (5), in which
the first consumption amount is consumption current estimated in advance, and
the second consumption amount is power consumption estimated during operation.

(7) The consumption amount estimation device according to any one of the above (1) to (6), in which
the consumption information includes the first consumption amount per processing time in the plurality of control blocks, and
the consumption amount estimation unit estimates the second consumption amount on a basis of time required for processing in the plurality of control blocks.

(8) A satellite signal receiver including:
a front-end control block configured to receive a satellite signal from a satellite and perform signal processing;
a satellite capture control block configured to capture the satellite signal;
a satellite tracking control block configured to track the satellite signal;
a positioning control block configured to measure a position of a satellite signal receiver on a basis of the satellite signal;
a consumption information holding unit that holds consumption information in which a first consumption amount is estimated in advance for each of a plurality of control blocks including the front-end control block, the satellite capture control block, the satellite tracking control block, and the positioning control block; and
a consumption amount estimation unit that estimates a second consumption amount in a predetermined period on a basis of the consumption information according to an operation state of each of the plurality of control blocks within the predetermined period.

### REFERENCE SIGNS LIST

100 Satellite signal receiver
101 Antenna
110 Radio frequency circuit
111-1 L1 band analog signal processing unit
111-2 L2 band analog signal processing unit
111-3 L5 band analog signal processing unit
112-1 L1 band analog-to-digital conversion unit
112-2 L2 band analog-to-digital conversion unit
112-3 L5 band analog-to-digital conversion unit
120 Observation unit
121 Digital front-end
1211-1 L1 band digital signal processing unit
1211-2 L2 band digital signal processing unit
1211-3 L5 band digital signal processing unit
122 Satellite capture unit
123 Tracking/satellite data extraction unit
130 Positioning unit
140 State acquisition unit
150 Power estimation unit
151 Aggregation unit
152 Consumption current information holding unit
160 CPU
170 Power supply unit
191 Front-end control block
192 Satellite capture control block
193 Satellite tracking control block
194 Positioning control block
200 Host computer
250 Power estimation unit
500 Positioning satellite

1. A consumption amount estimation device for a satellite signal receiver, comprising:
a consumption information holding unit that holds consumption information in which a first consumption amount is estimated in advance for each of a plurality of control blocks in a satellite signal receiver that receives a satellite signal from a satellite and generates position information; and
a consumption amount estimation unit that estimates a second consumption amount in a predetermined period on a basis of the consumption information according to an operation state of each of the plurality of control blocks within the predetermined period.

2. The consumption amount estimation device for a satellite signal receiver according to claim 1, wherein
the plurality of control blocks includes a front-end control block for receiving the satellite signal and performing signal processing, and
the consumption information includes the first consumption amount according to a height of an analog-to-digital conversion sampling frequency, a height of a clock frequency, or presence or absence of operation of a noise filter for each frequency band of the satellite signal.

3. The consumption amount estimation device for a satellite signal receiver according to claim 1, wherein
the plurality of control blocks includes a satellite capture control block for capturing the satellite signal, and
the consumption information includes the first consumption amount according to a number of satellites related to the satellite signal to be simultaneously captured, a height of a clock frequency, or a parameter for capturing the satellite signal.

4. The consumption amount estimation device for a satellite signal receiver according to claim 1, wherein
the plurality of control blocks includes a satellite tracking control block for tracking the satellite signal, and
the consumption information includes the first consumption amount for each channel according to a synchronization parameter for each of the satellite signals, a decoding state for each of the satellite signals, or a height of a clock frequency.

5. The consumption amount estimation device for a satellite signal receiver according to claim 1, wherein
the plurality of control blocks includes a positioning control block for measuring a position of the satellite signal receiver on a basis of the satellite signal, and
the consumption information includes the first consumption amount according to the number of satellites used to measure the position of the satellite signal receiver.

6. The consumption amount estimation device for a satellite signal receiver according to claim 1, wherein
the first consumption amount is consumption current estimated in advance, and
the second consumption amount is power consumption estimated during operation.

7. The consumption amount estimation device for a satellite signal receiver according to claim 1, wherein
the consumption information includes the first consumption amount per processing time in the plurality of control blocks, and
the consumption amount estimation unit estimates the second consumption amount on a basis of time required for processing in the plurality of control blocks.

8. A satellite signal receiver comprising:
a front-end control block configured to receive a satellite signal from a satellite and perform signal processing;
a satellite capture control block configured to capture the satellite signal;
a satellite tracking control block configured to track the satellite signal;
a positioning control block configured to measure a position of a satellite signal receiver on a basis of the satellite signal;
a consumption information holding unit that holds consumption information in which a first consumption amount is estimated in advance for each of a plurality of control blocks including the front-end control block, the satellite capture control block, the satellite tracking control block, and the positioning control block; and
a consumption amount estimation unit that estimates a second consumption amount in a predetermined period on a basis of the consumption information according to an operation state of each of the plurality of control blocks within the predetermined period.
